(19) United States
(12) Patent Application Publication
(10) Pub. No.: US 2007/0087246 A1
(43) Pub. Date: Apr. 19, 2007

(54) Materials and methods for making proton exchange polymers, polymer membranes, membrane-electrode assemblies and fuel cells

(76) Inventors: Hwan Soo Shin, Anyang-si (KR); Hee Woo Rhee, Seoul (KR); Young Taek Kim, Seoul (KR); Jong Hyun Lee, Seongnam-si (KR); Ji-Soo Kim, Seoul (KR)

Correspondence Address: MORGAN, LEWIS & BOCKIUS LLP (SF), 2 PALO ALTO SQUARE, 3000 El Camino Real, Suite 700, PALO ALTO, CA, 94306, US

(21) Appl. No.: 11/305,729

(22) Filed: Dec. 15, 2005

(30) Foreign Application Priority Data
Oct. 18, 2005 (KR) 10-2005-0098270

(51) Int. Cl. H01M 8/10; C08J 5/22

(52) U.S. Cl. 429/33; 521/27

(57) ABSTRACT

The present invention provides materials and methods for making proton conductive polymer, polymer membranes comprising the proton conductive polymer, membrane-electrode assemblies comprising the polymer membrane, and fuel cells comprising the membrane-electrode assemblies. The proton conductive polymer can be formed in the following manner: a) silicon inorganic polymers and silane compounds having amino groups are dissolved in a solvent to form a precursor; b) said precursor undergoes condensation polymerization to form a network of inorganic polymers; and c) the network and a reactant are contacted with one another to form the proton conductive polymer.

### CROSS REFERENCE TO RELATED APPLICATION

This application claims priority of Korean Patent Application No. 10-2005-0098270, filed on Oct. 18, 2005 with the Korean Intellectual Property Office, the disclosure of which is fully incorporated herein by reference.

### FIELD OF THE INVENTION

The present invention relates to a proton conductive polymer comprising an inorganic polymer and methods of preparing same. Additionally, the present invention relates to a membrane comprising said proton conductive polymer and methods of preparing same.

### BACKGROUND OF THE INVENTION

A fuel cell is an electrochemical energy conversion device that converts the chemical energy of fuel and oxidant directly into electricity. Recently, due to growing concerns over environmental pollution, exhaustion of energy resources and rising appeal of fuel cell vehicles, there is an urgent need to develop reliable and efficient fuel cells that can deliver high performance and operate at higher temperatures.

There are many different types of fuel cells, e.g. molten carbonate fuel cell (MCFC) which operates at a relatively high temperature of 500° C. to 700° C., phosphoric acid fuel cell (PAFC) which operates at around 200° C., alkaline fuel cell (AFC) which operates at room temperature or about 100° C., and polymer electrolyte fuel cell, etc. Of these, the polymer electrolyte fuel cell has the highest power density and conversion rate, making it a likely alternative to fossil fuels as a sustainable energy supply. Due to the polymer electrolyte fuel cell's operability at room temperature and advantage in size and sealing properties, it has wide-ranging applications in vehicles, home power systems, telecommunication devices, medical devices, military equipments, space equipments and the like.

Polymer electrolyte fuel cells can be further divided into proton exchange membrane fuel cells (PEMFC), which uses hydrogen gas as fuel, and direct methanol fuel cells (DMFC), which uses methanol as fuel.

A PEMFC can generate electricity directly by means of electrochemical reactions of hydrogen and oxygen. Its most basic structure is characterized by a proton conductive polymer membrane between a positive electrode, a cathode, and a negative electrode, an anode. The parts of a PEMFC can include: 1) a proton conductive polymer membrane, which typically measures 50 to 200 μm in thickness; 2) an anode and a cathode each comprising a substrate layer that supplies the reaction gas; 3) catalyst layer(s) facilitating the oxidation/reduction reactions (hereinafter referred to as “gas diffusion electrode”); and 4) carbon plate(s) that function as current collectors with gas supplying channel(s). The catalyst layer of the gas diffusion electrode is formed on the substrate layer, which can be made of carbon cloth, carbon paper or other suitable materials. The substrate layer in turn may be treated to optimize its ability to transport reaction gases and water, etc.

When the reactant gas, hydrogen, is supplied, an oxidation reaction occurs at the anode to convert hydrogen molecules into hydrogen ions and electrons, and the converted hydrogen ions are transported to the cathode through the proton conductive polymer membrane. At the cathode, a reduction reaction occurs to convert oxygen molecules into oxygen ions and the produced oxygen ions react with the hydrogen ions transferred from the anode to produce water.

The proton conductive polymer membrane in fuel cells is an electrical insulator, which serves the dual functions of transferring hydrogen ions from the negative electrode to the positive electrode when the battery is in operation and separating oxidant gas from fuel gas or liquid. As such, the membrane should have excellent mechanical strength, electrochemical and thermal stability, and exhibit minimal resistance and swelling during operation.

Of the most widely used membranes is the fluorinated polymer membrane, e.g., Nafion®, which includes fluorinated alkylene as a main chain with sulfonic acid groups at the end of fluorinated vinyl ether branches. However, such fluorinated polymer membranes are not sufficiently cost-efficient to be feasible for applications in fuel cell vehicles. Furthermore, they are limited to operating temperatures below 100° C. since elevated temperatures can lead to membrane dehydration, which thereby reduces structural integrity and proton conductivity. Fluorinated polymer fuel cells also cannot operate at elevated temperatures at atmospheric pressure due to the increased resistance from membrane dehydration; instead, they require more than 3 atm pressure to be operable at elevated temperatures. Another drawback of electrolyte membranes of the prior art is that phosphoric acid tend to leach out during humidification, which gradually diminishes the efficiency and overall utility of the fuel cell in which they are used.

There is therefore an increasing demand to develop improved polymer materials and organic/inorganic composites. Up until now, efforts in this regard have not met with success. One example is heat-resistant aromatic polymers, including polybenzimidazole, polyether sulfones, polyether ketones, which have low solubility that makes them difficult to incorporate in electrolyte membranes. The use of inorganic materials with a high water absorption rate, e.g. silica, has also been considered but these materials have little to no conductivity as compared with organic materials.

### SUMMARY OF THE INVENTION

The present invention provides materials and methods for making proton conductive polymer, polymer membranes comprising the proton conductive polymer, membrane-electrode assemblies and fuel cells comprising the polymer membrane. The proton conductive polymer can be formed as follows: a) silicon inorganic polymers and silane compounds having amino groups are dissolved in a solvent to form a precursor; b) said precursor undergoes condensation polymerization to form a network of inorganic polymers; and c) the network and a reactant are contacted with one another to form the proton conductive polymer. The polymer prepared according to the invention is ion-conductive, robust yet flexible, and electrochemically and thermally stable and suitable for applications in electrolyte membranes for fuel cells. As will be explained, the characteristics of the proton conductive polymer enable membranes formed therefrom to maintain their ion conductivity and structural integrity even at high temperatures and pressures.

These and other objects, features, and advantages of the invention will be apparent to those of skill in the art based on this disclosure in conjunction with the accompanying drawings.

### BRIEF DESCRIPTION OF THE DRAWINGS

FIG. 1 is a FT-IR graph of the polymer membrane of polydimethylsiloxane/3-aminopropyltriethoxysilane/phosphoric acid prepared according to a preferred embodiment of the invention; and

FIG. 2 is a graph comparing the ion conductivity of an electrolyte membrane of the present invention and a commercially available NAFION 117 membrane at different temperatures.

### DETAILED DESCRIPTION OF THE INVENTION

In the present invention, a method for preparing proton conductive polymers is provided, wherein a) silicon inorganic polymers and silane compounds having a structure of chemical formula (1) below, are dissolved in a solvent to form a precursor; b) said precursor undergoes condensation polymerization to form a network of inorganic polymers; and c) the network and a reactant are contacted with one another to form the proton conductive polymer.
Si(OR)₃(CH₂)ₙNH₂ (1)

wherein R is a member selected from hydrogen and an alkyl group having 1 to 6 carbons, and n is an integer selected from 0 to 5. In this manner, the polymer formed by the process of the present invention comprises hydrogen ion exchanging groups that are attached to the amino group of silane compounds having a structure of chemical formula (1). The unique structure of the resulting polymer provides various advantages over electrolyte polymers of the prior art, as will be described in detail.

According to the method of the present invention, hydrophobic silicon inorganic polymers and silane compounds having a structure of chemical formula (1) are dissolved to prepare a polymer precursor solution. In one embodiment of the invention, the silicon inorganic polymer comprises siloxane. In other embodiments of the invention, the hydrophobic polymer comprises a homogenous or heterogenous mixture of siloxane with one or more binding groups selected from the group consisting of monomethacrylate, vinyl, hydride, distearate, bis(12-hydroxy-stearate), methoxy, ethoxyrate, propoxyrate, diglycidyl ether, monoglycidyl ether, monohydroxy, bis(hydroxyalkyl), chlorine, bis(3-aminopropyl), and bis((aminoethyl-aminopropyl)dimethoxysilyl) ether. In further embodiments of the invention, the hydrophobic polymer employed comprises a heterogenous mixture of silicon inorganic polymers with and without the aforementioned binding groups.

An example of a silicon inorganic polymer that can be used is poly(dimethylsiloxane). Preferably, the poly(dimethylsiloxane) molecule(s) selected has a molecular weight (“MW”) ranging from 300 to 10,000. Most preferably, the poly(dimethylsiloxane) molecule(s) selected has a MW ranging from about 550 to about 1,500. Using molecules with a MW of less than 550 will cause the mechanical properties of the membrane to deteriorate. On the other hand, using molecules with a MW greater than 1,500 will lead to a reduction in ion conductivity of the membrane formed using the proton conductive polymer of the present invention. The appropriate molecule(s) to use can be determined by one of skill in the art based on the present disclosure to achieve the object of the invention.

In preferred embodiments of the present invention, about 2 mol to about 2.5 mol of silane compounds having a structure of chemical formula (1) is used for every mol of hydrophobic silicon inorganic polymers such that a silane compound can react with each end of a silicon inorganic polymer. If the mole ratio is less than about 2, there would be insufficient silane compounds to form the desired precursor. In contrast, a mole ratio of greater than about 2.5 will result in an excess of unreacted reactants, which negatively affect the mechanical properties of the final proton conductive polymer formed by the process.

In theory, any solvent can be employed to dissolve the silicon inorganic polymer and silane compound. Preferably, an organic solvent is employed. Even more preferably, the organic solvent is a solution comprising one or more of the group consisting of N-methyl-2-pyrrolidinone (NMP), dimethylformamide (DMF), dimethyl acetamide(DMA), tetrahydrofuran(THF), dimethyl sulfoxide(DMSO), acetone, methyl ethyl ketone(MEK), tetramethyl urea, trimethyl phosphate, butyrolactone, isophorone, carbitol acetate, methyl isobutyl ketone, N-butyl acetate, cyclohexanone, diacetone alcohol, diisobutyl ketone, ethyl acetoacetate, glycol ether, propylene carbonate, ethylene carbonate, dimethyl carbonate, and diethyl carbonate.

The amount of organic solvent employed should yield a solution containing about 5 wt % to about 10 wt % of polymer precursors. A concentration of polymer precursor below about 5 wt % would negatively impact the mechanical properties of a membrane formed using the proton conductive polymer of the invention. However, an excess of about 10 wt % polymer precursor would increase the viscosity and, thus, the processability of the solution. The appropriate amount of organic solvent to use can be varied by one of skill in the art to achieve the object of the invention.

Essentially, the silicon inorganic polymers used in the present invention conjugate with the silane compounds having a structure of chemical formula (1) to form a polymer precursor, which is then polymerized to form a network of inorganic polymers. In one embodiment, the polymer precursor solution is stirred and heated at temperatures of about 80° C. to about 100° C. for 12 to 20 h. to form a network of inorganic polymers.

Hydrogen ion exchanging groups, e.g. phosphoric acid, sulfuric acid, and acetic acid moieties, are then added to the amino groups of the silane compounds within the network of inorganic polymers to form the proton conductive polymer of the present invention. However, since phosphoric acid does not readily react with said amino groups at rm or even temperatures higher than 100° C., a preferred embodiment involves contacting the network of inorganic polymers with a reactant such as phosphorus oxychloride (POCl₃) or sulfurous oxychloride (SOCl₂) to form the proton conductive polymer. In theory, any reactant that can readily react with the amino groups of the silane compounds so as to add hydrogen ion exchanging groups thereto is suitable for use in the present invention, although POCl₃ and SOCl₂ are most preferred.

The phosphorus oxychloride, sulfurous oxychloride, or any other reactant that is employed for the aforementioned purpose is preferably in an aqueous state. In this manner, the hydrogen ion exchanging groups contemplated by the present invention can be formed to constitute a proton conduction channel without any additional requirement for water. Preferably, about 0.5 mol to about 1 mol of such reactant is employed for every mol of silane compound. A mol ratio of less than about 0.5 would result in poor channel formation. If a mol ratio of greater than about 1 is used, unreacted reactant will be precipitated out. The precise amount of reactant to use can be varied by one of skill in the art.

Methods by which such hydrogen ion exchanging groups can be added to the silane compounds are generally known and practiced by those skilled in the art. Preferably, the reaction occurs at temperatures ranging from about 0° C. to about 10° C. over a period of 3 to 5 h. A proton conductive polymer is thereby obtained.

To further illustrate the present invention, the following is an exemplary schematic of one embodiment of the present invention. The proton conductive polymer structure is prepared using polydimethylsiloxane (PDMS) as the silicon inorganic polymer and 3-aminopropyltriethoxysilane (3-APTES) as the silane compound according to formula 1. As shown below, the hydrogen ion exchanging groups in this particular example are all phosphoric acid moieties. It should be noted that other hydrogen ion exchanging groups are also appropriate for achieving the object of the present invention.

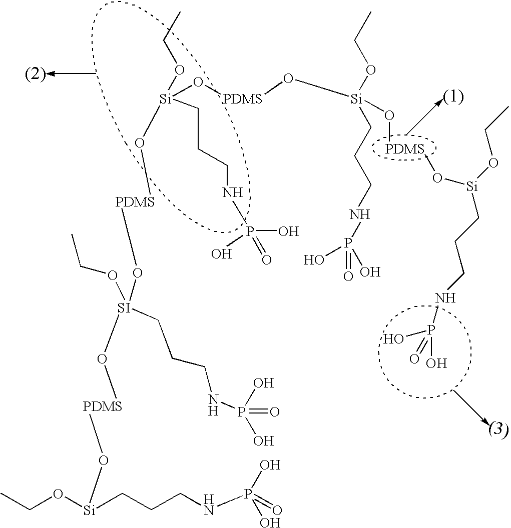

In the embodiment shown above, each 3-aminopropyltriethoxysilane molecule has three ethoxy groups and one aminopropyl group. Focusing for a moment on the silane compound enclosed within the dotted circle, note that two of its ethoxy groups are connected with the hydroxy groups of adjacent PDMS molecules while the third ethoxy group polymerizes with adjacent ethoxy groups to form a network. In this manner, a network of inorganic polymers is formed. The Si—O—Si bonds in PDMS provide flexibility and thermal, chemical, and electrochemical stability to the overall structure. The 3-APTES, together with PDMS, forms the backbone of the network structure and serves several important functions, e.g. providing mechanical strength and flexibility, facilitating film formation, and forming channels for hydrogen ion transport.

Referring back to the above schematic, the addition of hydrophilic hydrogen ion exchanging groups to the amino groups of 3-APTES, which is connected to the hydrophobic silicon inorganic polymer effectuates a phase separation. This phase separation between the hydrophobic —Si—O—Si— backbone and hydrophilic amino branches permits the formation of a circular channel for hydrogen ion transport, which enhances the proton conductivity of a membrane formed using the proton conductive polymer of the invention. Such membrane is operable at both rm and elevated temperatures and at various pressures. Additionally in this embodiment, the placement of phosphoric acid moieties at the ends of the aminopropyl group of 3-APTES brings the hydrogen ion exchanging groups into closer proximity with one another so as to facilitate proton transfer.

A membrane can be prepared using the proton conductive polymer of the present invention by a variety of methods known in the art, e.g. solution casting method or heat compression method. These methods can be applied to the present invention to prepare a membrane of the desired thickness. Preferably, the polymer membrane has a thickness of about 30 μm to about 125 μm since membrane thickness of greater than about 125 μm results in lowered proton conductivity as well as increased manufacturing cost. However, a membrane with a thickness of less than about 30 μm tends to have poor mechanical properties.

The present invention further provides a membrane-electrode assembly for a polymer electrolyte fuel cell comprising the polymer electrolyte membrane of the present invention, sandwiched between a cathode and an anode, each having a catalyst layer adjacent to the polymer electrolyte membrane, and methods of preparing same.

The present invention also provides fuel cells having a membrane-electrode assembly prepared by the aforementioned method that can operate at elevated temperatures and a wide range of pressures. The fuel cells provided by the present invention have the basic structure of the conventional proton exchange membrane fuel cell (PEMFC) described in the Background section of the instant application, but with the proton exchange polymer membrane of the present invention comprised therein to enhance the fuel cell's operability under more extreme conditions, e.g. elevated temperatures, high and low pressures.

A fuel cell's operability at elevated temperatures is advantageous for a number of reasons. Higher temperatures can accelerate reactions in the fuel cell, thereby promoting system efficiency, and avoiding or minimizing carbon monoxide poisoning of the platinum catalyst(s). Carbon monoxide poisoning occurs when hydrocarbons from the modified hydrogen fuel are oxidized and converted into carbon monoxide molecules which absorb to the surface of the platinum catalyst, thereby lowering the fuel cell's performance over time. Since the adsorption of carbon monoxide is an exothermic reaction, operating the fuel cells at elevated temperatures will work to alleviate deactivation of the catalyst and to help sustain the fuel cell's performance over time.

Additionally, a fuel cell comprising the polymer electrolyte membranes described above can operate without additional external pressure, which obviates or at least reduces the need for a pressure control device or humidifier. Likewise, the fuel cell's ability to perform on less amount of platinum catalyst reduces the overall cost of production and achieves an increase in efficiency.

The following examples are provided by way of illustration only and not by way of limitation. Those of skill in the art will readily recognize a variety of non-critical parameters that could be changed or modified to yield essentially similar results.

### EXAMPLES

### Example

### Preparation of a Proton conductive Polymer Using polydimethylsiloxane (PDMS)/3-aminopropyltriethoxysilane (3-APTES)/phosphorous oxychloride (POCl₃)

Five g of PDMS and 4.0249 g of 3-APTES were dissolved in toluene and the resulting solution was heated to 80° C. and reacted for 12 h. The mol ratio of [3-APTES]/[PDMS] was kept at 2. Phosphorous oxychloride (POCl₃) in the amount of 2.7878 g was added to enhance conductivity and prepare for subsequent curing. The mol ratio of [3-APTES]/[POCl₃] was 1, and the reaction temperature was kept at 0° C. After stirring for 1 h., the solvent was evaporated to produce a gel complex of PDMS/3-APTES/POCl3.

The gel complex was poured onto mylar film, and a membrane with uniform thickness was prepared therefrom using a doctor blade (300 μm). The prepared membrane was then cured for 12 h. on a clean bench and dipped into deionized water at rm prior to its use.

### Comparative Example

Nafion 117 proton conductive polymer membrane (Dupont Inc.; thickness=175 μm) was treated with hydrogen peroxide at 100° C. for 3 h. to remove contaminates then treated with 1M sulfuric acid solution at 100° C. for 2 h. and kept in deionized water.

### Experimental Example 1

### FT-IR Analysis

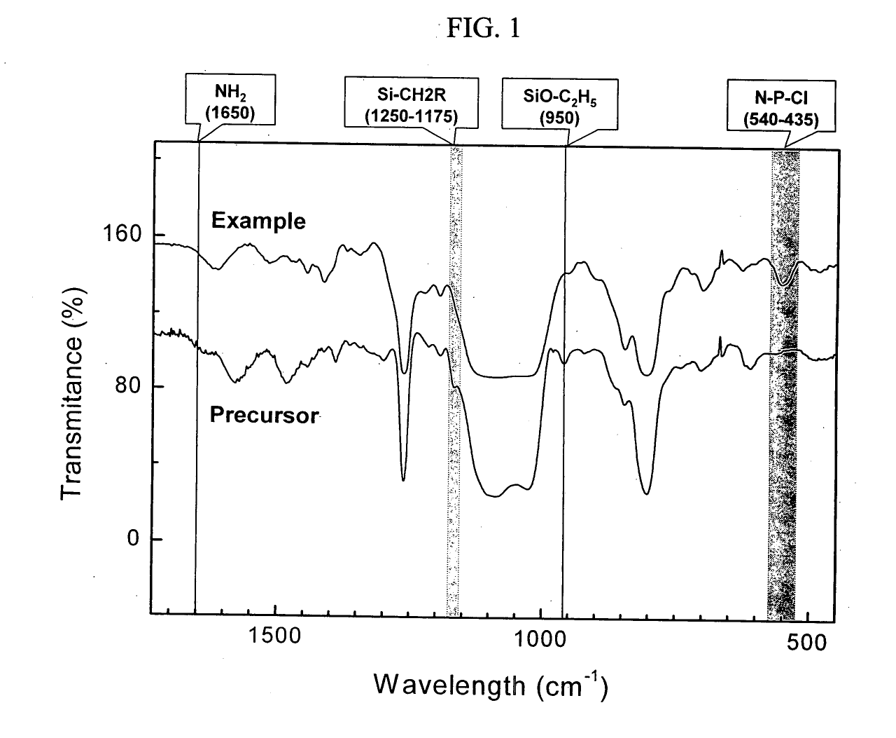

The PDMS/3-APTES/POCl₃ membrane prepared according to the invention was analyzed with FTS-3000MX(BIO-RAD); the results from that analysis are shown in FIG. 1. The conditions during analysis are as follow:

Wave number: 4000 to 400 cm⁻¹

Temperature: 25° C.

Humidity: 50%

Experimental Example 2

### Determination of hydrogen ion conductivity

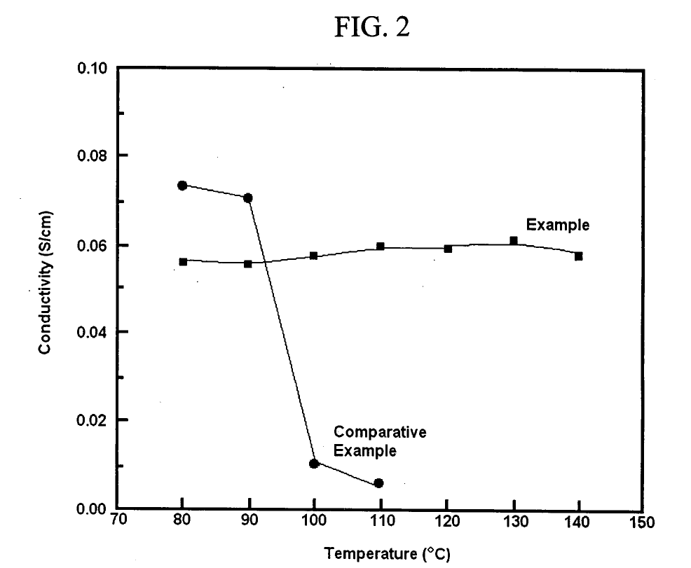

Conductivities of the PDMS/3-APTES/POCl₃ membrane, hereinafter also referred to as the “Example” and prepared according to the invention, and Nafion 117, hereinafter also referred to as the “Comparative Example,” were determined using the four point probe. Membrane samples measuring 1 to 5 cm on each side were prepared and kept in a temperature and humidity-controlled chamber. AC current was applied both ends of the sample, and the potential difference at the center of the sample determined to obtain the proton conductivity. See FIG. 2 for the results.

As shown therein, the conductivity of the sample of the Nafion 117 increases with temperature until the temperature reached about 100° C., at which point a rapid drop occurred. This drop is attributed to the membrane dehydration or evaporation of water at temperatures of 100° C. and above, which reduces the medium, e.g. water, necessary for proton transport.

In comparison, the PDMS/3-APTES/POCl₃ membrane, which is not dependent on water for proton transport, exhibits relatively stable conductivity both at temperatures below 100° C. and temperatures above 100° C. The relatively stable conductivity is attributed to the fact that membrane produced by the present invention uses phosphoric acid as a medium for proton transport. As such, there is no precipitation of phosphoric acid from water below 100° C. and no rapid drop of conductance above 100° C.

All documents mentioned herein are incorporated herein by reference in their entireties. Even though the present invention is described in detail with reference to the foregoing embodiments, it is not intended to limit the scope of the present invention thereto. It is evident from the foregoing that many variations and modifications may be made by a person having an ordinary skill in the present field without departing from the essential concept of the present invention.

What is claimed is:

1. A method for preparing a proton conductive polymer comprising:
a) dissolving silane compounds comprising an amino group, having the structure of formula:
Si(OR)₃(CH₂)ₙNH₂
wherein
R is a member selected from hydrogen and an alkyl group having 1 to 6 carbons, and n is an integer selected from 0 to 5, and silicon inorganic polymers to form a precursor;
b) polymerizing the precursors to form a network of inorganic polymers; and
c) contacting the amino groups in the network and a reactant to form the proton conductive polymer, wherein the proton conductive polymer comprises hydrogen ion exchanging groups.

2. The method of claim 1, wherein about 2 mol to about 2.5 mol of silane compounds are used per 1 mol of silicon inorganic polymer.

3. The method of claim 1, wherein about 0.5 mol to about 1 mol of hydrogen ion exchanging groups are used per 1 mol of silane compounds.

4. A proton conductive polymer prepared by the method of claim 1.

5. The proton conductive polymer of claim 4, wherein said inorganic polymer comprises siloxane.

6. The proton conductive polymer of claim 5, wherein said inorganic polymer comprises a mixture of siloxane with one or more binding groups selected from the group consisting of monomethacrylate, vinyl, hydride, distearate, bis(12-hydroxy-stearate), methoxy, ethoxyrate, propoxyrate, diglycidyl ether, monoglycidyl ether, monohydroxy, bis(hydroxyalkyl), chlorine, bis(3-aminopropyl), and bis((aminoethyl-aminopropyl)dimethoxysilyl) ether.

7. The proton conductive polymer of claim 4, wherein the hydrogen ion exchanging groups are selected from one or more of the group consisting of phosphoric acid, sulfuric acid, and acetic acid.

8. A proton conductive polymer membrane comprising the proton conductive polymer of claim 4.

9. The proton conductive polymer membrane of claim 8, wherein said proton conductive polymer membrane has a thickness of about 30 μm to about 125 μm.

10. A membrane electrode assembly comprising the proton conductive polymer membrane of claim 8.

11. A fuel cell comprising the membrane electrode assembly of claim 10.
